(19) United States
(12) Patent Application Publication
(10) Pub. No.: US 2023/0347273 A1
(43) Pub. Date: Nov. 2, 2023

(54) PRE-FILTER MODULES FOR IMPROVING AIR QUALITY

(71) Applicant: Jiajiu Shaw, Frisco, TX (US)

(72) Inventor: Jiajiu Shaw, Frisco, TX (US)

(21) Appl. No.: 17/731,430

(22) Filed: Apr. 28, 2022

(51) Int. Cl. B01D 46/00; A47L 9/12; F24F 8/108

(52) U.S. Cl. CPC B01D 46/0043; B01D 46/0027; B01D 46/0038; A47L 9/12; F24F 8/108; B01D 2279/55; B01D 2279/50

(57) ABSTRACT

An air pre-filter module that is designed and configured to be used in conjunction with air filtration and air cleaning systems that use filters, including commercial and residential heating and air conditioning systems, motor vehicle heating and air conditioning systems, free standing air filtration or cleaning systems and vacuum cleaners that include filters or bagless vacuums. The air pre-filter modules are positioned upstream of conventional air filters and perturb the airflow entering the conventional air filters thereby improving the efficiency of the conventional air filters to remove airborne particles. The air pre-filter modules can include chemical agents that neutralize pathogens, adhesive coatings that trap particles, fragrance oils that add a scent to the filter air and/or fabric strips with loops or hooks that trap hair and other fibrous materials.

### BACKGROUND

The present invention relates generally to air filtration and more particularly relates to air pre-filter modules that can be used in conjunction with air filtration and air cleaning systems that use filters, including commercial and residential heating and air conditioning systems, motor vehicle heating and air conditioning systems, free standing air filtration or cleaning systems and vacuum cleaners that include filters or bagless vacuums.

Conventional air filters media are made of different filtering materials including fiber glass, polypropylene, polyester, polyurethane foam, etc. A pleated filter is an air filter that uses a folding pattern with its media so that the surface area and filtering efficiency can be increased as opposed to un-pleated filter media. Currently, pleated filters are commonly used because of the better air filtering efficiencies.

An efficiency standard commonly used for air filters is called HEPA (high-efficiency particulate air). Filters meeting the HEPA standard must satisfy very high levels of efficiency to remove tiny particulates. As defined by the United States Department of Energy (DOE) standard adopted by most American industries, HEPA filters remove at least 99.97% of aerosols 0.3 micrometers (μm) in diameter. Therefore, HEPA filters are relatively more expensive than other types of filters.

A HEPA filter can be used in conjunction with a carbon-activated pre-filter to remove most of the larger particles to extend the usage life of the more expensive HEPA filter.

It is reasonable to use a secondary filter up stream of a primary HEPA to remove larger particles, thereby extending the usage life of a HEPA filter. However, smaller particles going through such secondary filters would play an important role in shortening the usage life of a HEPA filter. Currently, there are no such secondary filters on the market that increase the usage life of HEPA filters.

In addition, there are other issues associated with current air filtering systems with respect to the air quality, whether it be the air coming out of the air filtering system in a building, a car, or a vacuum cleaner. These include unpleasant odors and microbes in the filtered air.

In terms of bagless vacuum cleaners, there are several undesirable issues that need to be resolved. When dumping the dust collector/bin of a bagless vacuum cleaner the fine particulates being dumped create a dust plume that is unhealthful and unpleasant. Another undesirable issue associated with bagless vacuum cleaners involves the collection of both human and animal hair. Because of the fibrous nature and light weight of hair, the hair easily becomes tangled and trapped in the dust collector/bin and does not drop down/out easily. Users usually have to use their hands to grasp and remove hair from bagless vacuum cleaner dust collectors/bins. Even after removing hair, it is often still difficult to thoroughly clean the dust collectors/bins because of the fine particulates that collect in the dust collectors/bins and tend to statically adhere to the internal surfaces of bagless vacuum cleaners.

### BRIEF SUMMARY

According to various features, characteristics and embodiments of the present invention which will become apparent as the description thereof proceeds, the present invention provides an air filtering system in combination with an air pre-filter module, said air filtering system having an air filter through which incoming air passes to remove airborne particles, said air pre-filter module being positioned in front of the air filter and including a plurality of air deflecting blades that perturb airflow entering the air filter in the air filtering system.

The air pre-filter module comprises a frame component and a working component supported within the frame component. The working component includes the plurality of air deflecting blades and a plurality of supporting blades that form a grid pattern with the air deflecting blades. The grid pattern can have a geometric or random shape, and the overall air pre-filter module can have a geometric or non-geometric shape.

The air deflecting blades are aligned in an acute angle with respect to a direction of the airflow of the incoming air and the plurality of supporting blades are aligned parallel to the airflow of the incoming air.

In some embodiments least some of the plurality of supporting blades and/or some of the air deflecting blades have irregular shaped edges and/or rough surfaces.

In other embodiments at least some of the plurality of supporting blades and/or some of the air deflecting blades have an adhesive coating thereon, a releasable fragrance applied thereto and/or have fabric strips attached thereto which fabric strips include at least one of loops or hooks.

In further embodiments two or more air pre-filter modules are coupled together and positioned in front of the air filter.

In other embodiments one or more air pre-filter modules and an air filter are combined together as an integral unit.

The air pre-filter modules can be used in various air filtering systems, including building heating and/or air conditioning systems, vehicle heating and/or air conditioning systems, vacuum cleaners and free standing air cleaning system.

### BRIEF DESCRIPTION OF THE DRAWINGS

The present invention will be described with reference to the attached drawings which are given as non-limiting examples only, in which:

FIG. 1A is front planar view of an air pre-filter module according to one embodiment of the present invention.

FIG. 1B is a perspective view of the air pre-filter module of FIG. 1A.

FIG. 2A is a front planar view of an air pre-filter module according to another embodiment of the present invention.

FIG. 2B is a perspective view of the air pre-filter module of FIG. 2A.

### DETAILED DESCRIPTION OF THE DRAWINGS AND THE PRESENTLY PREFERRED EMBODIMENTS

The modules of the present invention are referred to as “pre-filter” modules in the sense that they are designed and configured to be located upstream of conventional filters or filter elements that are used in commercial and residential heating and air conditioning systems, motor vehicle heating and air conditioning systems, free standing air filtration or cleaning systems and vacuum cleaners that include filters or bagless vacuum cleaners.

The air pre-filter modules of the present invention are designed and configured to perturb the pattern of airflow before the airflow contacts a conventional filter or filter element or the collectors/bins of a bagless vacuum cleaner. By perturbing the incoming airflow, the quality of air filtered by the filter or filter elements will be improved. In further embodiments of the present invention that are discussed below, internal surfaces of the air pre-filter modules can include an adhesive coating that will allow the air pre-filter modules to trap particulates out of an air stream. In other embodiments the internal elements of the air pre-filter modules can be treated with fragrance oils or compositions and/or different disinfecting chemicals to eliminate odors, add a scent to the filtered air or sanitize unhealthful microorganisms/pathogens.

The air pre-filter modules of the present invention are easily replaceable in positions upstream or in front of (and in tandem with) an air filter in the air duct of a building or vehicle or in a vacuum cleaner to perturb the airflow pattern and help improve the quality of air filtered through the air filter or coming out of a vacuum cleaner.

When in use in an air duct of a building or vehicle, the air pre-filter modules can be installed as independent units that are positioned immediately in front of an air filter or filter element. In alternative embodiments, the air pre-filter modules of the present invention can be attached or affixed onto an air filter or filter element.

When use in conjunction with vacuum cleaners, the air pre-filter modules of the present invention can be provided at a suitable position before the air filter (e.g., HEPA filter fora bagless vacuum cleaner) or the paper-bag dust collector of a vacuum cleaner by any convenient mechanism such as interference fit, twist-lock, threaded coupling, spring pin engagement or other conventional connection mechanisms. Optionally the air pre-filter modules can be made in the form of a cartridge with suitable O rings on both ends so that the modules can be easily pulled/pushed out/into an air conduit of a vacuum cleaner. A suitable mark, such as an arrow sign, may be printed on the outside of the air pre-filter modules to correctly install/replace the modules. However, in some embodiments the air pre-filter modules can receive incoming air on either side.

The air pre-filter modules of the present invention include a frame component and a working component, with the working component affixed within the frame component.

The frame component may have any suitable geometric or non-geometric shape including a rectangular, a square shape, a circular shape, etc. The frame component can be sized and shaped to fit into the ductwork of a residential heating and air conditioning system or motor vehicle heating and air conditioning systems or into or onto a free standing air filtration or cleaning system or into or onto the airflow passages of a vacuum cleaner that includes filters or bagless vacuums. The frame component can be made of suitably rugged material(s) including paper, plastic, metal, or suitable composite materials so that the frame component will hold its shape in a given airflow. The frame component may be totally or partially transparent so that it is easier to tell whether the air pre-filter module needs to be replaced.

The working component that is supported within the frame component includes a plurality of thin blades that extend into the direction that the air will flow when the air pre-filter modules are used in conjunction with a filter or filter element. The thin blades are arranged in a grid having a repeating or random pattern within the frame component with air deflecting ones of the blades (“air deflecting blades”) being not parallel to airflow and supporting ones of the blades (“support blades”) being parallel to the airflow. The air deflecting blades cause the airflow to become perturbed before reaching a downstream filter or filter element. The support blades maintain the positions of air deflecting blades.

The air deflecting blades can be flat or curved. The leading and/or trailing free edges of the air deflecting blades and/or support blades preferably have irregular shape, such as zigzag shapes or wavy shapes, and rough surfaces. These features help perturb the airflow. In addition the irregular shaped edges can capture and retain fibrous material and hair and the rough surfaces can catch small particulates.

The working component can be made of rigged materials, including metals, plastics, paper, or suitable composite materials.

The working component may be coated with a suitable adhesive having good tackiness. When in use the adhesive may help catch small particulates and fibrous materials. The adhesive can be coated onto the working component using any convenient process including spraying, dipping, brushing, etc.

If desired, the adhesive may be blended with chemicals such as anti-microbial chemicals that kill microbes, antiviral chemicals, disinfecting agents, etc. which will neutralize pathogens from the air.

In further embodiments a fragrance oil or compound can be applied to the working component or blended with an adhesive that is applied to the working component. If further embodiments the air pre-filter modules can be color-coded to aid consumers in identifying the different functionalities provided by the components coated onto or applied to the working components.

In yet further embodiments of the air pre-filter modules one or a plurality of linear fabric strips with tiny loops or hooks (preferably made of nylon or polyester) may be adhered onto the blade(s) of said working component. When in use, the tiny loops or hooks of these fabric strip(s), can catch and retain hair and other fibrous materials.

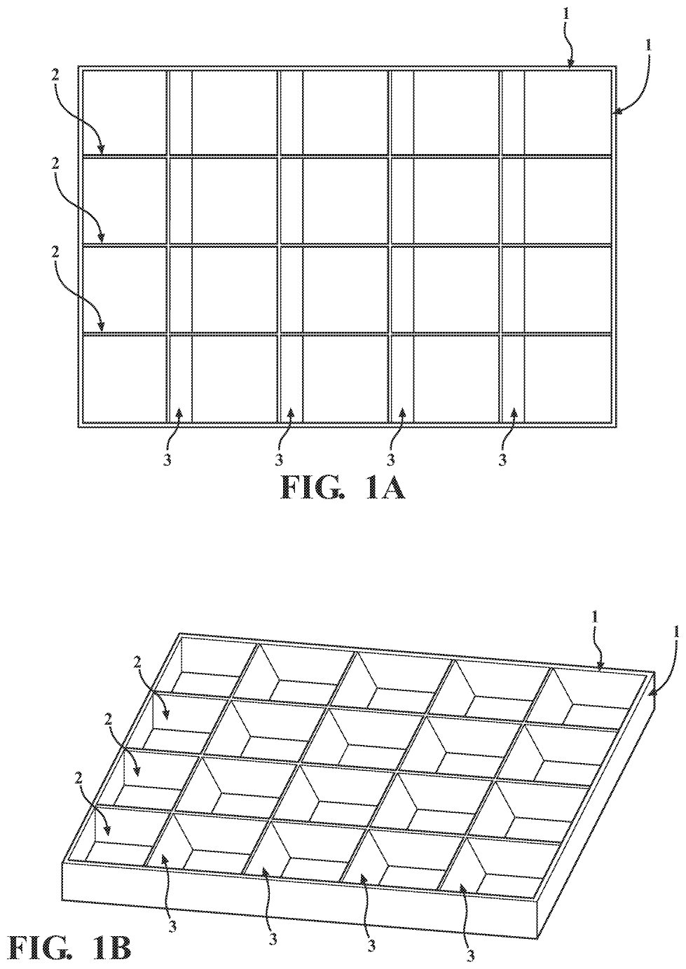

FIG. 1A is front planar view of an air pre-filter module according to one embodiment of the present invention. FIG. 1B is a perspective view of the air pre-filter module of FIG. 1A.

The air pre-filter module shown in FIGS. 1A and 1B includes a frame component 1 that is in the shape of a rectangle. Within the frame component 1 is a grid of thin blades, including support blades 2 and air deflecting blades 3. In FIG. 1A the airflow would be directed either into the page or out of the page. Thus the thickness of supporting blades 2 are shown in FIG. 1 and the lengths of the air deflecting blades 3 are shown since the air deflecting blades 3 are aligned at an acute angle with respect to the airflow. Air flows in the spaces between the support blades 2 and air deflecting blades 3 in FIG. 1. The air pre-filter modules can receive incoming air on either side.

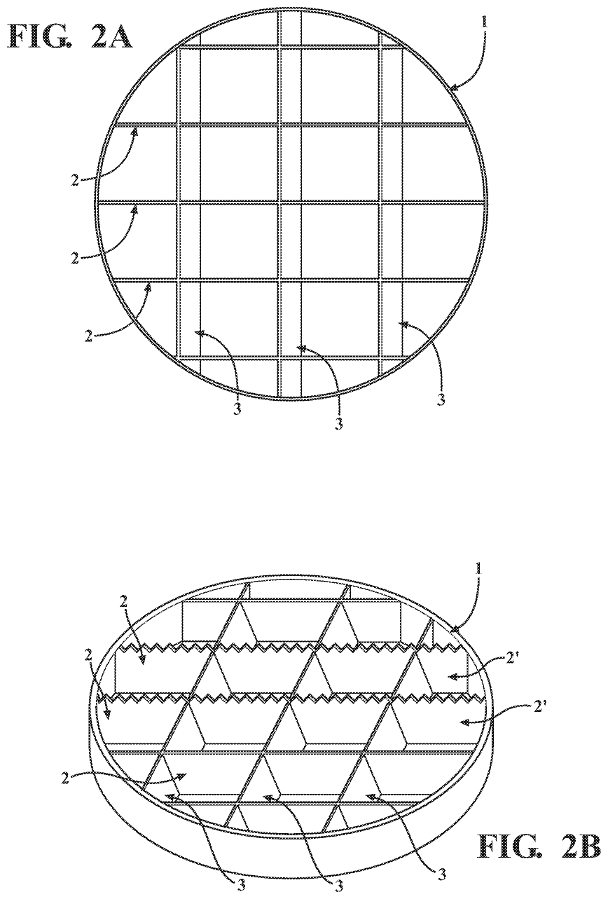

While the supporting blades 2 and air deflecting blades 3 are arranged in a regular geometric pattern in FIGS. 1A and 1B (and FIGS. 2A and 2B), the supporting blades 2 and air deflecting blades 3 can be arranged in any desired regular or irregular pattern. The air deflecting blades 3 can all be configured to be oriented in the same or similar angle with respect to the airflow or at different and/or opposing angles to one another. In alternative embodiments the angular orientation of the air deflecting blades 3 could change between adjacent supporting blades 2.

The lengths of the air deflecting blades 3 can be the same or substantially the same or could vary between adjacent air deflecting blades or vary between adjacent supporting blades 2.

FIG. 2A is a front planar view of an air pre-filter module according to another embodiment of the present invention. FIG. 2B is a perspective view of the air pre-filter module of FIG. 2A.

The air pre-filter module shown in FIGS. 2A and 2B has a circular shape defined by the frame component 1. As in the case of the air pre-filter module of FIGS. 1A and 1B, within the frame component 1 of FIGS. 2A and 2B is a grid of thin blades, including support blades 2 and air deflecting blades 3. In FIG. 2B the leading free edges 2′ of the support blades 2 are irregular shaped in a zigzag or wavy manner. The only difference between the embodiment of the air pre-filter module of FIGS. 1A-1B and 2A-2B is the overall shapes of these embodiments. All of the alternative embodiments and features discussed in reference to FIGS. 1A and 1B are applicable to the air pre-filter module embodiment of FIGS. 2A and 2B. The difference on overall shape just allows the air pre-filter modules to be used in different shaped ductwork or airflow channels.

Use of the air pre-filter modules of the present invention will allow a reduction in the frequency at which HEPA filters need to be replaced in household and industrial in air ducts, thus saving money, because a substantial portion of tiny particulates and fibrous materials can be retained in the air pre-filter modules upstream of HEPA filters when the air pre-filter modules are provided with an adhesive and/or strips of fabric with loops and/or hooks.

In addition use of the air pre-filter modules help to reduce the need to frequently replace HEPA filters in bagless vacuum cleaners or conventional vacuum cleaners that use conventional paper filter bags, again because a substantial portion of tiny particulates and fibrous materials can be retained in the air pre-filter modules.

Use of the air pre-filter modules will improve air quality without reducing the air filtering efficiency, because the air pre-filter modules trap certain tiny particulates, reduce or eliminate odors and microbes without affecting the airflow.

Use of the air pre-filter modules will make the process of dumping debris from vacuum dust collectors less unpleasant and healthier especially when a lot of hair is collected, because the air pre-filter modules can trap fibrous materials by several mechanisms, such as providing the leading free edges support blades and/or air deflecting blades with an irregular shape such as a zigzag or wavy shape.

If desired the air pre-filter modules of the present can be made by environmentally friendly materials so that they can be easily recycled.

In further embodiments of the present invention two or more of the air pre-filter modules can be used together as separate modules that are positioned in front of an air filter or filter element in the ductwork of a building or vehicle or in a vacuum cleaner. Alternatively two (or more) of the air pre-filter modules could be combined together to form a single tandem module that can be positioned in front of an air filter or filter element in the ductwork of a building or vehicle or in a vacuum cleaner.

When two or more of the air pre-filter modules are used together separately or configured into a single tandem module, the grid patterns of support blades and air deflecting blades of the individual working components can be aligned or unaligned. When two separate air pre-filter modules are used, they can be attached together with clips or any convenient mechanical means. Otherwise the frame components can include cooperative attaching structures such as slots and protrusions, channels, etc. that will allow two or more of the frame components to engage and attached together. In the case of integral tandem modules, as single frame component could include two or more of the working components with the grid patterns of support blades and air deflecting blades of the two or more working components being aligned or unaligned.

The use of two or more separate air pre-filter modules or a tandem filter element having two or more working components can increase the degree to which the air is perturbed prior to contacting an air filter or filter element thereby causing more small particulates and/or fibrous materials may be retained.

All of the alternative embodiments and features discussed in reference to FIGS. 1A-2B and 1B are applicable to the tandem modules and cooperative use of two or more separate air pre-filter modules.

In further embodiments of the present invention one or more of the air pre-filter modules can be combined with a conventional air filter or filter element to form a single integral air pre-filer/filter unit that can be sized and shaped to fit into the ductwork of a residential heating and air conditioning system or motor vehicle heating and air conditioning systems or into or onto a free standing air filtration or cleaning system or into or onto the airflow passages of a vacuum cleaner. In such air pre-filter/filter units a single frame component can be used to support the working component of the air pre-filter module and the filter element of a conventional air filter.

All embodiments of the present invention can be made using currently available industrial technologies/processes. As to applying or coating the support blades and/or air deflecting blades of the working components, a desired adhesive, chemicals agents such as anti-microbial chemicals, antiviral chemicals, disinfecting agents, etc. and/or fragrance oils/compositions, one can mask off the frame component and immerse the air pre-filter modules in a solution of these coating materials or mask off and spray these coating materials onto selective portions of the support blades and/or air deflecting blades.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

1. An air filtering system in combination with an air pre-filter module, said air filtering system having an air filter through which incoming air passes to remove airborne particles, said air pre-filter module being positioned in front of the air filter and including a plurality of air deflecting blades that perturb airflow entering the air filter in the air filtering system.

2. The combination of claim 1, wherein the air pre-filter module comprises a frame component and a working component supported within the frame component, said working component including said plurality of air deflecting blades.

3. The combination of claim 2, wherein said frame component further includes a plurality of supporting blades that form a grid pattern with the sir deflecting blades.

4. The combination of claim 1, wherein the air deflecting blades are aligned in an acute angle with respect to a direction of the airflow of the incoming air.

5. The combination of claim 3, wherein the air deflecting blades are aligned in an acute angle with respect to a direction of the airflow of the incoming air and the plurality of supporting blades are aligned parallel to the airflow of the incoming air.

6. The combination of claim 3 wherein at least some of the plurality of supporting blades and/or some of the air deflecting blades have irregular shaped edges.

7. The combination of claim 3 wherein at least some of the plurality of supporting blades and/or some of the air deflecting blades have rough surfaces.

8. The combination of claim 3 wherein at least some of the plurality of supporting blades and/or some of the air deflecting blades have an adhesive coating thereon.

9. The combination of claim 3 wherein at least some of the plurality of supporting blades and/or some of the air deflecting blades have a releasable fragrance applied thereto.

10. The combination of claim 3 wherein at least some of the plurality of supporting blades and/or some of the air deflecting blades have fabric strips attached thereto which fabric strips include at least one of loops or hooks.

11. The combination of claim 1, wherein another air pre-filter module is provided and the air pre-filter modules are coupled together and positioned in front of the air filter.

12. The combination of claim 1, wherein the air pre-filter module and the air filter are combined together as an integral unit.

13. The combination of claim 3, wherein the plurality of supporting blades and the plurality of air deflecting blades for a grid pattern that has a geometric shape.

14. The combination of claim 1, wherein the air pre-filter module has a geometric shape.

15. The combination of claim 1, wherein the air filtering system comprises a building heating and/or air conditioning system.

16. The combination of claim 1, wherein the air filtering system comprises a vehicle heating and/or air conditioning system.

17. The combination of claim 1, wherein the air filtering system comprises a vacuum cleaner.

18. The combination of claim 17, wherein the vacuum cleaner comprises a vacuum cleaner with a filter bag.

19. The combination of claim 17, wherein the vacuum cleaner comprises a bagless vacuum cleaner.

20. The combination of claim 1, wherein the air filtering system comprises a free standing air cleaning system.
